(19) United States
(12) Patent Application Publication
(10) Pub. No.: US 2007/0126977 A1
(43) Pub. Date: Jun. 7, 2007

(54) Three-dimensional combining structure for an auxiliary lens set

(76) Inventor: Chia-Yung Cheng, Sinjhuang City (TW)

Correspondence Address: Troxell Law Office Pllc, Suite 1404, 5205 Leesburg Pike, Falls Church, VA, 22041, US

(21) Appl. No.: 11/540,953

(22) Filed: Oct. 2, 2006

(30) Foreign Application Priority Data
Dec. 6, 2005 (TW) 094221176

(51) Int. Cl. G02C 9/00

(52) U.S. Cl. 351/47

(57) ABSTRACT

A three-dimensional combining structure for an auxiliary lens set in which a single operating point between spectacles and an auxiliary lens set enables assembly and disassembly thereof. The combining structure mainly includes magnetic elements located in a vertical relationship on an upper surface and inner surface of a bridge of the spectacles, thereby enabling magnetic attachment and combination with correspondingly located magnetic members of a center bridge of an auxiliary lens set. Moreover, the magnetic lines of force are used to form a vertical diagonal arrangement that enables single operating point assembly and disassembly, and that attains three-dimensional angular magnetic combining forces after assembly.

### BACKGROUND OF THE INVENTION

(a) Field of the Invention

The present invention relates to a three-dimensional combining structure for an auxiliary lens set, and more particularly to a single operating point between spectacles and an auxiliary lens set that enables assembly and disassembly thereof, and to a structure that forms three-dimensional angular magnetic combining forces.

(b) Description of the Prior Art

Optical effective spectacle sets are provided with an auxiliary lens set having additional filter functionality, which offers multifunction convenience and are thus widely popular.

Related commercially available prior art spectacles providing a combinatory filtering and auxiliary lens set configuration include component elements having a magnetic function are located on a bridge of spectacles, and inverted hook elements having a magnetic function backward extend from a corresponding bridge of an auxiliary lens set.

Furthermore, the spectacles are provided with three magnetic elements located at a center of a bridge and two side end pieces of the spectacles, wherein, in order to achieve three-dimensional fixed combining forces, inverted hook portions with related magnetic elements are located on an auxiliary lens corresponding to angular positions of the bridge and end pieces.

Another spectacles of prior art include magnetic elements firmly fastened to screw positions that lock lenses to spectacles rims, bar supports that extend from a bridge of an auxiliary lens corresponding to the magnetic elements, and magnetic elements located and joined to ends of the bar supports. However, because dimensions and shape of each type of spectacle lenses are different, thus, such configurations are unable to successfully accommodate all spectacle lenses.

Apart from having the aforesaid shortcomings, moreover, because strength of combinatory force is fixed to a single-axis or double-axis, thus, the auxiliary lens set of each of the aforementioned combinatory magnetic configurations easily moves from side to side from the effect of external forces, which causes contortion. Reason for such being that curvature of the lenses of the auxiliary lens set causes normal incident light rays entering the lenses to deviate, and is particularly affected by unstable wind force. Under a situation whereby the auxiliary lens set has been made to sway, then light rays entering the eyeballs produce different angular positioned refracted rays, resulting in deviation of the incident light rays, and thereby affecting distorted vision.

Commonly available spectacles on the international market have magnetic devices located at two sides of a spectacles frame, hook fastening elements located on a center bridge, and magnetic hook fastening elements are located at two sides of the spectacles frame, and magnetic elements are configured in a vertical relationship. When using the aforementioned prior art, under a situation whereby limb movements of a user are large and fast, because of displacement speed of a head portion multiplied by mass of the auxiliary lens set produces energy of motion that can cause the auxiliary lens set to break off. Moreover, the multi-angular fastening is unable to stop the auxiliary lens set from coming apart, and because of a relatively complicated structure, combining operation requires mutual correspondence of a plurality of structural areas, which results in a substantially inconvenient assembly.

Recently, in order to obtain better stable combinatory method, a configuration as depicted in FIG. 1 has been introduced; wherein bridge 2 of spectacles 1 enables an auxiliary lens set 10 to hook fasten thereto. Lenses 11 are joined to left and right sides of the bridge 2, and temple arms 13 are respectively joined to end pieces 12, and the bridge 2 enables the auxiliary lens set 10 to attach thereto. The auxiliary lens set 10 provides an inverted hook support 3, two sides of which extend end bars 31 that enable filter lenses 100 to join thereto. Extended bars 32 backwardly extend from the end bars 31, and ends of the extended bars 32 further downwardly extend to form inverted hook bars 33. A connecting portion 34 is joined between the inverted hook bars 33, and function of the inverted hook bars 33 is to enable the inverted hook support 3 to attached and hook onto the bridge 2 located on the spectacles 1. A simple mechanical elastic fastening means is used to fixedly attach the auxiliary lens set 10 to the spectacles 1. When combining the auxiliary lens set 10 to the spectacles 1, because of the need for a sliding hob force in order to form an elastic fastening, thus, metallic surface damage of the inverted hook support 3 and the bridge 2 results. Moreover, friction and scuffing results between inner side surfaces of the auxiliary lens set 10 and surfaces of lenses of the spectacles 1.

### SUMMARY OF THE INVENTION

In order to resolve the aforementioned shortcomings, a primary objective of the present invention is to provide a three-dimensional combining structure for an auxiliary lens set, which uses a single point position of a bridge to achieve three-dimensional angular magnetic combining forces, and adopts a single point assembly and disassembly operation between an auxiliary lens set and spectacles that effects a three-dimensional stable combination. Moreover, the combination prevents the auxiliary lens set from moving side to side due to external pressure. The combining structure primarily comprises magnetic elements located at a single position of a surface and inner side surface of the bridge of the spectacles correspondingly configured in a vertical angular position relationship to magnetic members located on a horizontal plate and a vertical strip of a center bridge the auxiliary lens set, thereby achieving the three-dimensional angular magnetic combination.

Another objective of the present invention is to employ an arrangement of the magnetic elements that provides the spectacles or the auxiliary lens set formed as an integral body for use thereof.

A third objective of the present invention is to provide each of the magnetic elements with a magnetic force, thereby strengthening combinatory magnetic field strength.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational schematic view of prior art using an inverted hook support to combine with spectacles.

FIG. 2 shows an elevational schematic view of configurational relationship of component members according to the present invention.

FIG. 3 shows a side cutaway view depicting combination of magnetic members of a center bridge and a bridge according to the present invention.

FIG. 4 shows a schematic view of FIG. 3 assembled.

FIG. 5 shows a rear elevational schematic view according to the present invention.

FIG. 6 shows an elevational schematic view of FIG. 5 assembled according to the present invention.

FIG. 7 shows an elevational view of another embodiment according to the present invention.

FIG. 8 shows a schematic view of FIG. 7 assembled according to the present invention.

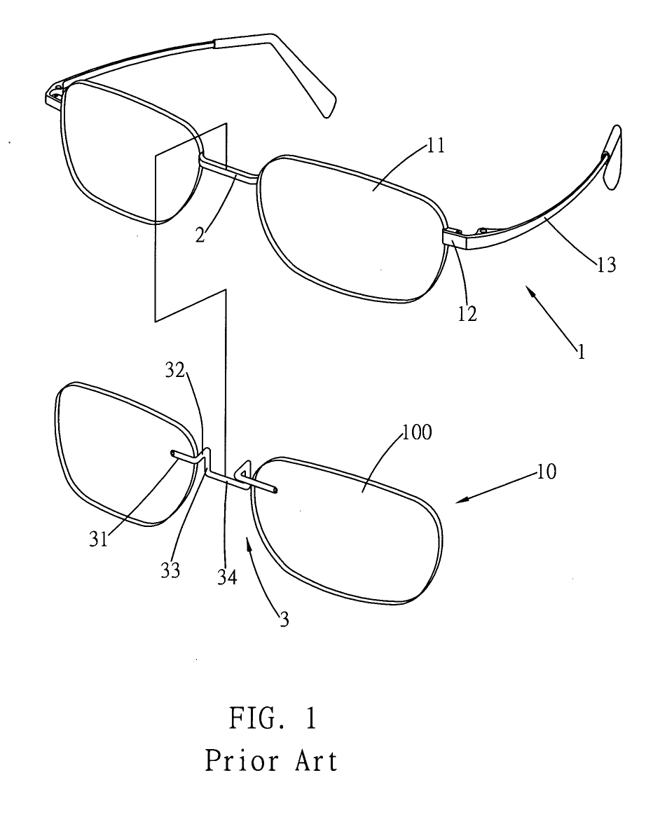

### DETAILED DESCRIPTION OF THE PREFERRED EMBODIMENTS

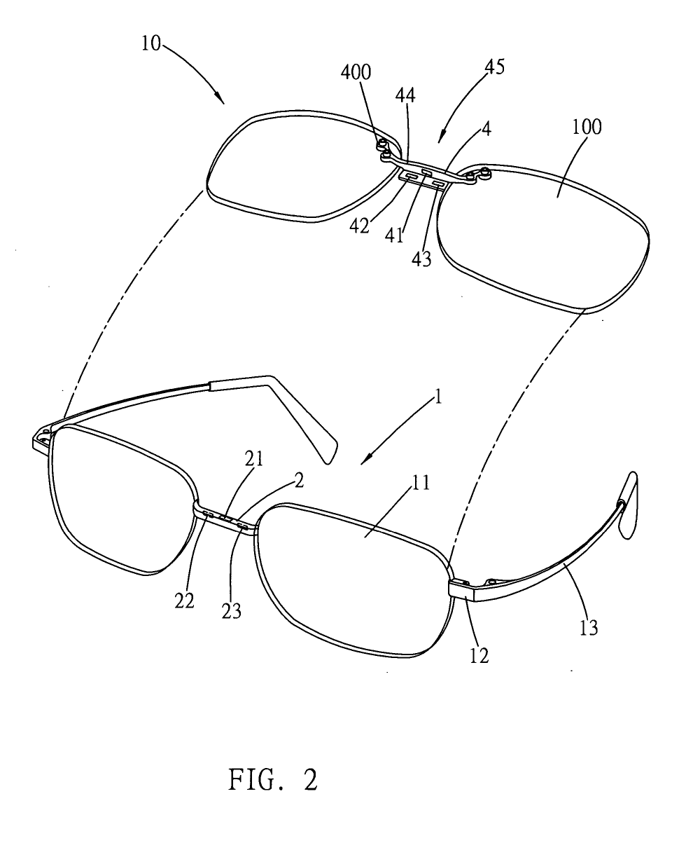

Referring to FIG. 2, which shows spectacles 1 primarily structured to comprise a first magnetic element 21 located on a surface of a bridge 2 thereof, a second magnetic member 22 and a third magnetic member 23 located on inward-facing vertical inner sides of the spectacles 1, lenses 11 respectively joined to sides of the bridge 2, and temple arms 13 are respectively pivot connect5ed to end pieces 12.

Side pieces 400 extending from left and right sides of a center bridge 4 located on an auxiliary lens set 10 are joined to filter lenses 100. A first magnetic member 41 is located on a horizontal strip 44 of the center bridge 4, and a second magnetic member 42 and a third magnetic member 43 are located on two sides of a vertical strip 45 of an extended rear side of the center bridge 4. Each of the aforementioned magnetic members 41, 42, 43 is provided with a magnetic force or is able to be magnetically attracted.

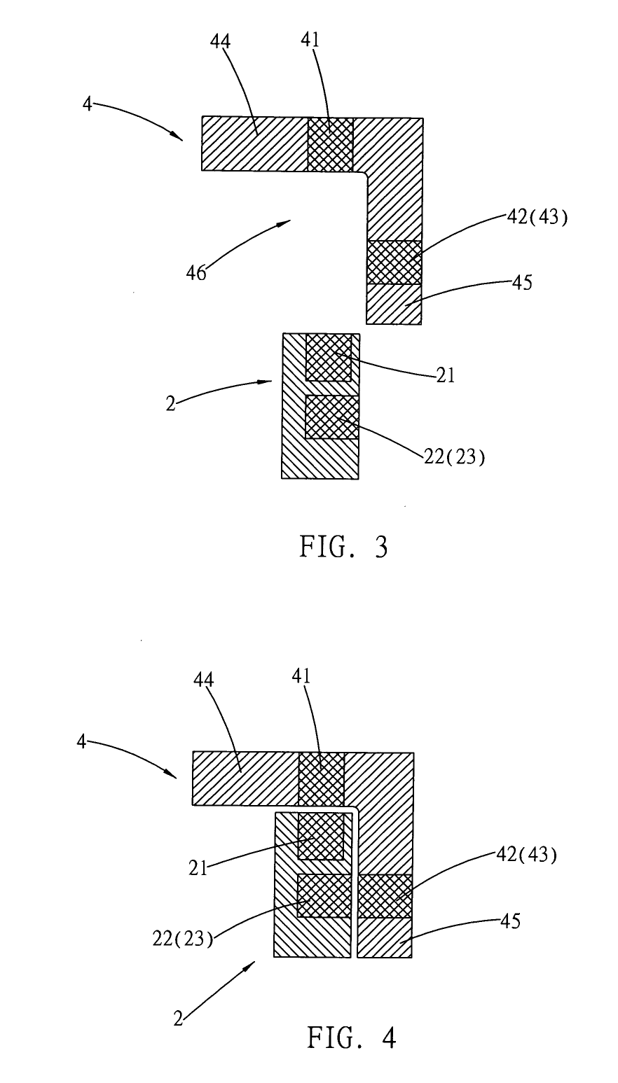

Referring to FIG. 3, wherein an upper end of the center bridge 4 located on the auxiliary lens set 10 forms the horizontal strip 44, the first magnetic member 41 is located on the horizontal strip 44, and the vertical strip 45 extends vertically downwards from a rear side of the horizontal strip 44. The second magnetic member 42 and the third magnetic member 43 are located on the vertical strip 45. The first magnetic member 21 is correspondingly located on the upper surface of the bridge 2 of the spectacles 1, and the second magnetic element 22 and the third magnetic element 23 are located on the rear side of the bridge 2. A concave recess 46 is downwardly formed between the horizontal strip 44 and the vertical strip 45 of the center bridge 4, and the recess 46 enables hooking onto the bridge 2.

Referring to FIG. 4, according to the configuration and attachment method as depicted in FIG. 2, the first magnetic member 41 located on the center bridge 4 is able to join normal to the corresponding first magnetic element 21 located on the bridge 2 to form a Y-combining force; the second and third magnetic members 42, 43 located on the center bridge 4 are then able to magnetically attract the corresponding second and third magnetic members 22, 23 located on the bridge 2 to form a Z-combining force.

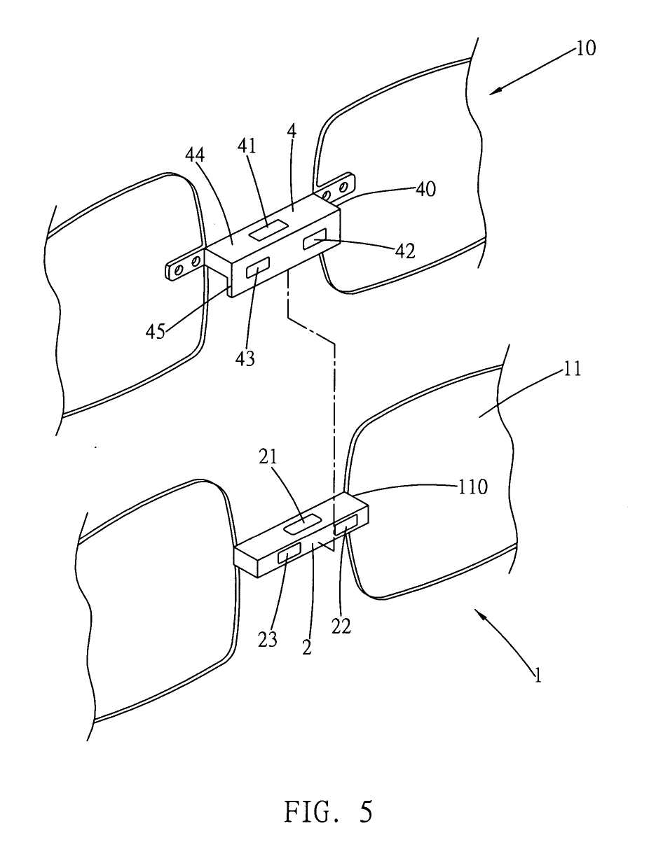

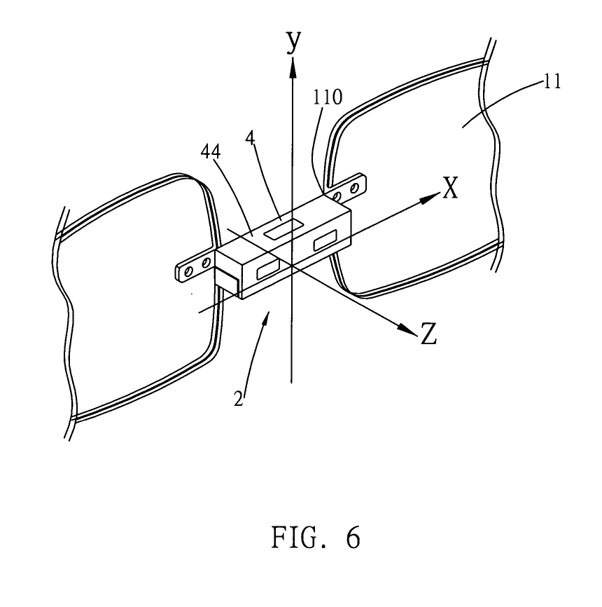

Referring to FIG. 5, and in accordance with attachment methods of FIG. 3 and FIG. 4, procedure for joining the auxiliary lens set 10 to the spectacles 1 uses the center bridge 4 of the auxiliary lens set 10 to hook onto the bridge 2 located on the spectacles 1, thereby enabling the magnetic members 41, 42, 43 located on the center bridge 4 to magnetically join to the corresponding magnetic elements 21, 22, 23 located on the bridge 2 to form a magnetic join therebetween, After joining side ends 40 of the center bridge 4 to angle ends 110 that connect the bridge 2 to the lenses 11, the center bridge 4 straddles the bridge 2 forming a mechanical combining mode, and the angle ends 110 assist in restricting position.

Referring to FIG. 6, after assembling, the center bridge 4 transversally straddles the angle ends 110, and uses magnetic attraction between the magnetic members 41, 42, 43 and respective magnetic elements 21, 22 23 to form a three-point vertical relationship and attain Y, X, Z three-axis combining force. The X-axis combining force can better use existence of the angle ends 110 to enable juxtaposition of the horizontal strip 44 of the center bridge 4 and aftain mechanical auxiliary position fixing. When disassembling, the auxiliary lens set 10 is upwardly displaced to form a magnetic trip.

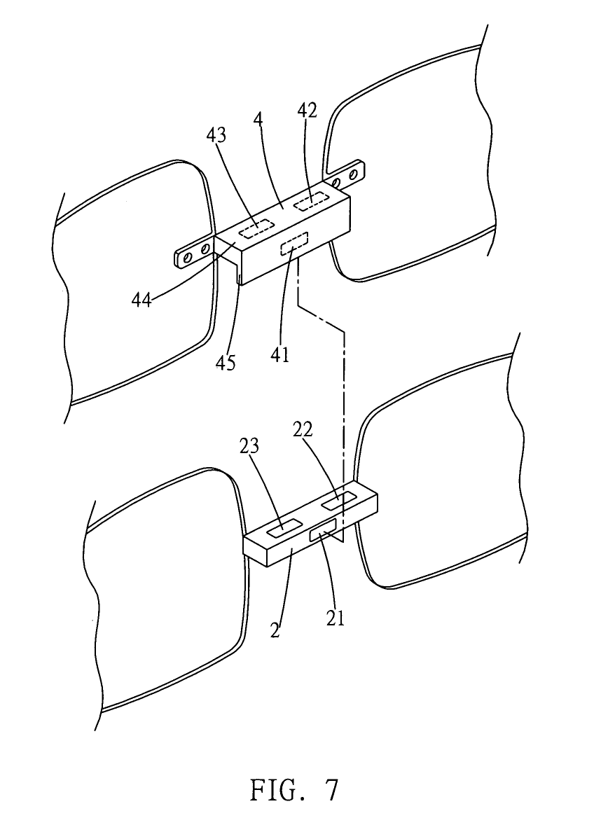

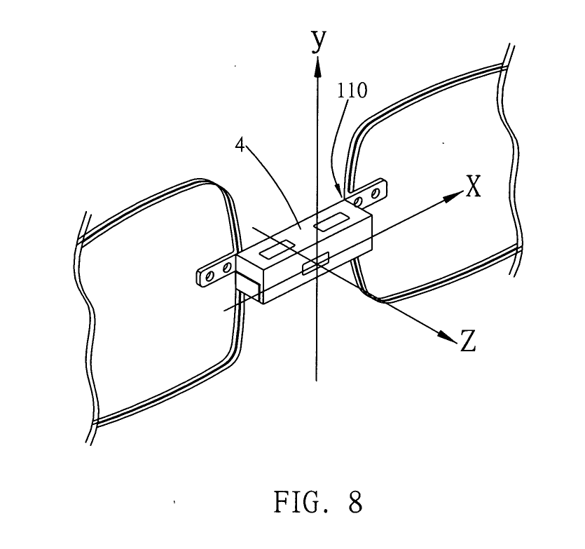

Referring to FIG. 7, wherein magnetic members and respective magnetic elements of the center bridge 4 and the bridge 2 are further arranged so that the first magnetic member 41 is disposed on the vertical strip 45, the second and third magnetic members 42, 43 are arranged on right and left sides of the horizontal strip 44 respectively, and the magnetic elements 21, 22, 23 are correspondingly arranged on the bridge 2, wherein the magnetic element 21 is located on an inner side surface of the bridge 2, and the second and the third magnetic elements 22, 23 are located on left and right sides of an upper surface of the bridge 2, thereby correspondingly achieving the three-dimensional angular combining method of FIG. 8. The associated X-axis function of the center bridge 4 uses the same principle of FIG. 5 to utilize the existence of the angle ends 110 of the lenses to enable the mechanical juxtaposed combination.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A three-dimensional combining structure for an auxiliary lens set, which enables attaining a three-dimensional angular combination between spectacles and an auxiliary lens set, comprising spectacles, lenses joined to two sides of a bridge of the spectacles and temple arms; magnetic elements are located on an upper surface and a vertical surface of an inner side of the bridge; and is characterized in that:
an auxiliary lens set comprises a center bridge, two sides of which are joined to filter lenses, an upper end of the center bridge is a horizontal strip, and a rear edge of the horizontal strip is downwardly connected to a vertical strip, magnetic members are located on the horizontal strip and the vertical strip corresponding to the magnetic elements of the bridge.

2. The three-dimensional combining structure for an auxiliary lens set according to claim 1, wherein a first magnetic element is located on an upper portion of the bridge, a second and a third magnetic element are located on inner side surface, a first magnetic member is located on the horizontal strip of the center bridge of the auxiliary lens set, and a second and a third magnetic member are located on the vertical strip.

3. The three-dimensional combining structure for an auxiliary lens set according to claim 1, wherein the second and the third magnetic elements are located on the upper portion of the bridge, the first magnetic member is located on the inner side surface, the second and the third magnetic members are located on the horizontal strip of the center bridge of the auxiliary lens set, and the first magnetic member is located on the vertical strip.

4. The three-dimensional combining structure for an auxiliary lens set according to claims 1, wherein each of the magnetic members are provided with a magnetic force.

5. The three-dimensional combining structure for an auxiliary lens set according to claims 2, wherein each of the magnetic members are provided with a magnetic force.

6. The three-dimensional combining structure for an auxiliary lens set according to claims 3, wherein each of the magnetic members are provided with a magnetic force.

7. The three-dimensional combining structure for an auxiliary lens set according to claim 1, wherein the spectacles are formed as an integral body, the first, second and third magnetic elements are located on the bridge, thereby enabling the corresponding magnetic members of the auxiliary lens set to combine therewith.

8. The three-dimensional combining structure for an auxiliary lens set according to claim 1, wherein the auxiliary lens set comprises lenses formed as an integral body, the first, the second and the third magnetic members are located on the center bridge, and each of the magnetic members function in correspondence with the respective magnetic elements located on the bridge of the spectacles.

9. The three-dimensional combining structure for an auxiliary lens set according to claim 7, wherein each of the magnetic elements is provided with a magnetic force.
